(19) United States
(12) Patent Application Publication
(10) Pub. No.: US 2025/0329007 A1
(43) Pub. Date: Oct. 23, 2025

(54) SYSTEM AND METHOD OF COMPOSITE MATERIALS INSPECTION FOR AERONAUTICS

(71) Applicant: AIRBUS OPERATIONS S.L.U., Getafe (ES)

(72) Inventor: Carlos Miguel Giraldo, Getafe (ES)

(21) Appl. No.: 19/184,239

(22) Filed: Apr. 21, 2025

(30) Foreign Application Priority Data
Apr. 23, 2024 (EP) 24382436

(51) Int. Cl. G06T 7/00; G01N 29/06; G01N 29/44

(52) U.S. Cl. CPC G06T 7/0004; G01N 29/0672; G01N 29/4445; G06T 2207/10081; G06T 2207/10132; G06T 2207/20084; G06T 2207/30108

(57) ABSTRACT

A NDI system and method for non-destructive inspecting aeronautical composite material parts include ultrasonics inspection equipment or device for generating raw inspection data of the composite material parts by using phased array, total focusing methodology, and phased coherence imaging, a computed tomography module for obtaining information of volumes of the composite material parts, data processor of cloud-shared resources configured to receive and process the raw inspection data from the ultrasonics inspection equipment and the information from the computed tomography module and to apply AI models created to identify defects within the composite part, the AI models trained using an inspection dataset obtained from the ultrasonics and the computed tomography inspection, and configured to classify the defects of the composite part according to a list of defect types and provide a classification output to make decisions.

### TECHNICAL FIELD

The disclosure herein relates to the field of Artificial Intelligent (AI) systems as part of computer science, within the software and information technology, and specially applied to aeronautics industry.

More particularly, the disclosure herein refers to a system and method for automatically performing Non-Destructive Inspection (NDI) and data processing during the production and repair phases of aeronautical composite material components, based on a methodology to create, develop and apply AI for the specific needs in aeronautics.

### BACKGROUND

The Non-Destructive Testing (NDT) or Non-Destructive Inspection (NDI) of aeronautical composite material components after their manufacturing process is a mandatory task in aeronautics both from the standpoint of Certification and the quality control process in Production. Today, this process is fundamentally carried out, given the intrinsic characteristics of the composite materials in the aeronautical and their defectology, through the Ultrasound Testing (UT) method using its various techniques: single-channel pulse-echo, transmission, and reflective plate, as well as Phased Array (PA) in its most modern versions. The most important requirements of these inspections in this manufacturing scenario are, apart from the reliability of the inspection to every time detect any heterogeneity that can affect to the structural integrity of the material, the repeatability, and reduction of scanning and processing times. One of the key aspects to achieve these requirements is the reduction of the human factor and the automation/robotization of the processes and operations.

Despite continuous efforts, there is still room for improvement not only in the automation and simplification of processes but even in the classification, and identification of defects or indications that may have an impact on the structural health of the components. Some of these defects are not easily characterised through current procedures. The conventional techniques for the analysis of inspection data (i.e., using UT) to detect and classify defects essentially consist of analysing a very small part of the (scanning) signal in the time domain, more particularly, the amplitude of the backwall echoes as well as the intermediate echoes and the Time-of-Flight (ToF) of each of the echoes, and apply criteria comparing these parameters with the ones expected in a material without defects.

Therefore, it is highly desirable to provide and qualify an intelligent system to perform automatic processing of NDI data for aeronautical composite parts, which improves the efficiency, reliability, and effectiveness of indication classifications of inspection processes in alignment with manufacturing paradigms in Industry 4.0, by using machine learning (ML) algorithms to identify and classify subtle defects that require today a lot time and resources to be properly classified by conventional methods and so improve the sensitivity, precision and time of the inspection.

### SUMMARY

The disclosure herein solves the aforementioned problems and overcomes previously explained state-of-art work topics by providing an artificial intelligent system and method of non-destructive inspection (NDI) for composite materials, which can be integrated within the process of work and development of technologies necessary for the complete digitalization of production plants and the concept of Industry 4.0. in aeronautics. The disclosure herein allows an automatic analysis of NDI data and automatic recognition of defects and their classification through previously created and trained artificial intelligence (AI) models.

The disclosure herein integrates different technologies/processes:
Inspection technologies based on the Ultrasonics (UT) with its most modern techniques, such as Phased Array (PA) using TFM (Total Focusing Methodology) and PCI (Phased Coherence Imaging). Additionally, the advanced version of X-Ray Computed Tomography is used, integrating spot sizes even smaller than 1 micron and digital detectors of the highest sensitivity, offering resolutions of a few microns in spatial terms.
A complete automation of the processes for preparing and positioning of components and/or parts of components, as well as the automatic scanning process of the parts/components for the acquisition of inspection data. The inspection systems and mechanical scanning as a whole are synchronized in spatial and temporal terms.
The processing of data for the extraction, characterization, and decision-making based on artificial intelligence (AI) regarding detected defects in the composite materials of the parts/components, which is carried out through a prior and simultaneous process with the serial inspection. The AI models are tailored for each of the different possible defects in each of the possible pieces/components to be inspected.
Cloud shared resources in which all the obtained inspection information by the previous processes is distributed, stored, and processed. These Cloud resources are associated and shared among the manufacturing or production plants and suppliers through a previously established security protocol. The goal is not only to centralize storage and computing resources but also to allow, through all inspection data, to continue feeding and training AI models to achieve greater reliability and precision in the results.

An aspect of the disclosure herein refers to a method for non-destructive inspection of aeronautical composite materials comprising the following steps:
for a composite material part given as input to the method, generating raw inspection data by ultrasonics (UT) inspection using phased array, total focusing methodology, and/or phased coherence imaging techniques;
to complement the inspection data, obtaining volumetric information of the composite material part by computed tomography (CT) inspection;
receiving and processing the inspection data generated by the UT and CT inspection, performed by ultrasonics inspection equipment and computed tomography module respectively, through data processing of cloud-shared resources;
applying a set of artificial intelligence (AI) models to identify defects within the composite material part, where the artificial intelligence models (140) are trained using an inspection dataset obtained from the ultrasonics inspection equipment and the computed tomography module;
classifying, according to a pre-defined list of defect types, the type of identified defects in the composite material part using each model from the set of AI models; and
providing a classification output information for the composite material part based on the classification of the type of identified defects within the composite material part, thereby enabling the identification and categorization of defects within the composite material parts in a non-destructive and efficient manner.

Another aspect of the disclosure herein refers to a system implementing the non-destructive inspection method described above for composite materials in the production line of aeronautical components/parts.

The disclosure herein is defined by the claims.

The disclosure herein has a number of advantages with respect to prior art, which can be summarized as follows:
Improvement in Inspection Sensitivity and Precision: Current NDI methods, including various ultrasound techniques, require sometimes a complex and very laborious manual procedure to adequately detect and classify some types of defects, particularly subtle or complex ones. The disclosure herein seeks to enhance the NDI data processing, enabling the automatic detection, identification and classification of structural defects that are currently not easily categorized with existing procedures.
Reduction of Human Intervention: The reliance on human operators for data analysis in NDI processes can introduce variability and potential for error, not to mention fatigue and the associated risks. The disclosure herein aims to automate data analysis, thus reducing human intervention and the potential for human error, and addressing issues related to operator fatigue.
Enhancement of Inspection Speed: The time taken for scanning and processing in the current NDI methods can be significant. The disclosure herein targets the reduction of essentially the processing time, aiming for a more efficient inspection process that can fit better within the production timelines, thereby improving the overall efficiency of the manufacturing and inspection processes.
Automation and Robotization: There's a recognized need to further automate and possibly robotize the NDI processes to achieve higher repeatability and reliability. The disclosure herein aims to address the need for more automated systems that can perform inspections with minimal human oversight.
Integration with Industry 4.0: Moving towards the complete digitalization of (local and external) production plants of an enterprise and aligning with the concepts of Industry 4.0 represents a significant technical challenge. The disclosure herein seeks to guide the development of new NDI processes that are fully integrated with digital manufacturing ecosystems, leveraging advancements in artificial intelligence and machine learning for data analysis and decision-making. Inspection data processing from worldwide manufacturing plants can be performed from a cloud-based software managed by the core location of the enterprise. This also can lead to the simplification of the certification requirements of personnel performing scanning NDT.
Compiling NDT production data of all the parts from worldwide plants and suppliers associated with the enterprise provides also valuable information to perform an innovative follow up of the evolvement of the quality process of the Plants (i.e., deterioration of the tooling, materials durability or drilling or trimming process among others)
Overcoming improvement aspects in Composite Material Inspection: The specific challenges associated with inspecting composite materials, such as assessment of porosity when surfaces are not parallel, multiple delamination, and other indications that may require a lot of effort by current NDI techniques, are a major focus of the disclosure herein. It aims to simplify some of the current bottleneck in NDT Production and improve the capability to automatically classify a wide range of composite material indications.
Adaptability and Scalability: The disclosure herein seeks to provide a scalable and adaptable solution that can be applied across different production plants and subcontractors, which involves creating a system that can handle the variability and specificity of different manufacturing environments and composite material applications.

These and other advantages will be apparent in the light of the detailed description of the disclosure herein.

### BRIEF DESCRIPTION OF THE DRAWINGS

For the purpose of aiding the understanding of the characteristics of the disclosure herein, according to a preferred practical embodiment thereof and in order to complement this description, the following Figures are attached as an integral part thereof, having an illustrative and non-limiting character:

FIG. 1 shows a schematic diagram of how the intelligent system for NDI of composite materials for aeronautical components works, according to a preferred embodiment;

FIG. 2 shows a schematic diagram of the inspection data and defects classification used by the system, according to a possible embodiment;

FIG. 3 shows a schematic diagram of how the artificial intelligent models are created, trained and validated for using the NDI system of composite materials in a production line of aeronautical components, according to a possible embodiment; and

FIG. 4 shows a conceptual representation of the global data management and automation of processes involved in the NDI system, according to the preferred embodiment, to explain the interrelation of the system components interconnected over internet among different production plants in various geographical locations and the flow of data for NDI managed from various points of the world.

### DETAILED DESCRIPTION

The embodiments of the disclosure herein can be implemented in a variety of architectural platforms, operating and server systems, devices, systems, or applications. Any particular architectural layout or implementation presented herein is provided for purposes of illustration and comprehension only and is not intended to limit aspects of the disclosure herein.

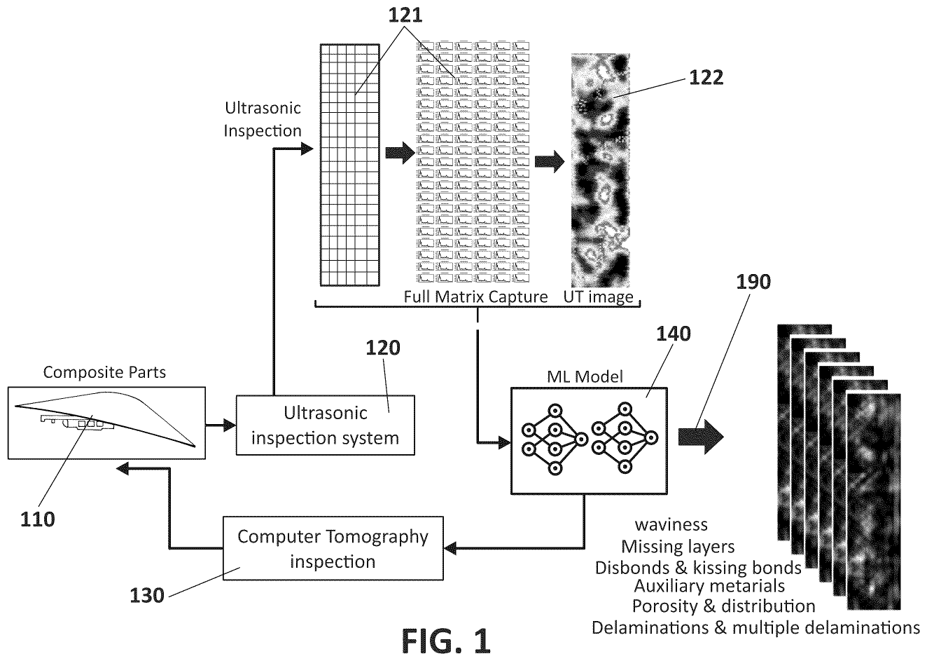

FIG. 1 presents a schematic view of a globalized NDI system, according to a preferred embodiment, which performs the inspection during the production or repair phase of aeronautical composite material components. FIG. 1 illustrates schematically how the NDI system allows the improvement of artificial intelligence (AI) models for evaluating composite material series parts. FIG. 1 also highlights the input flow of the composite material series parts that are to be inspected by the system. This integrated approach ensures a methodology of continuous inspection and improvement, where specific input data from the series parts facilitate the adaptation and optimization of AI models for specific applications in the field of composite materials. Firstly, the aeronautical composite material parts 110, 210 in production are input to be inspected by the system, wherein the inspection is based on UT or ultrasonic (PA, TFM, and PCI) methods implemented by ultrasonics inspection equipment 120 and computed tomography (CT) to obtain inspection data in a computed tomography module 130. The NDI system also integrates artificial intelligence (AI) modules/models 140, (previously trained and) fed by the (inspection training dataset and) inspection data, obtained by the UT equipment 120 and CT equipment 130. The CT inspection process is only applied in the production phase and only in particular cases where the system needs to tune the AI models 140 by using tomography data. The CT equipment 130 can also be a support in production inspections for specific situations where a second inspection is required for decision-making about the acceptance or rejection of the parts. The AI models 140 are generated for the detection, characterization, classification, and reporting of indications related to the presence (or not) of possible defects regarding the composite material input.

Unlike prior-art NDI processes, the reference standard parts (composite material input) used in the inspection performed by the proposed system shown in FIG. 1 and mandatory according to Quality NDT Procedures can include not only artificial defects inserted in a thickness steps but also other types of defects such as porosity, porosity distributed in a particular way, missing layer defects, or inserts of different auxiliary materials characteristic of the production process that can be detected and classified by artificial intelligence (AI) models 140 even as a mechanism to ensure that the process is working correctly. The requirement of these wide and representative defects in the reference standards can be also make imperative by the new qualification process to be followed to ensure the reliability and repeatability of the complete inspection process. The proposed system is based on a methodology to create, train, develop, mature, apply and validate the set of artificial intelligent models 140 configured to classify diverse type of defects according to a pre-defined list of defect types (defectology) and provide information in a classification output (190), which is the NDT output after applying acceptance criteria and classification.

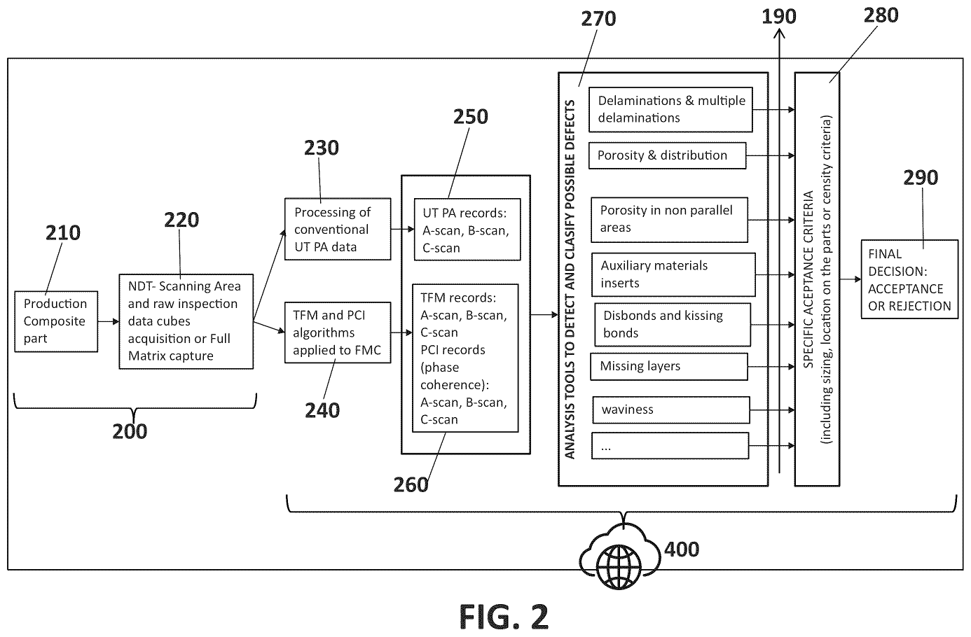

FIG. 2 shows in detail the defectology or different types of defects 270 to be covered which accounts for practically 100% of the relevant indications that can appear in the ultrasound inspection of aeronautical composite materials (e.g., carbon fiber reinforced plastic or CFRP: parts): delaminations, multiple delaminations, detection of porosity and its distribution (not only in parts with parallel faces but also in ramp configurations), disbonding in stiffened skin-stringer configurations, including “kissing bonds” detection of wrinkles within the material, detection of foreign objects from the manufacturing process, auxiliary material inserts, ply waviness, and detection of defects in the number of layers (missing of layers, included) as a result of inaccuracies in the process of taping composite materials during the production stage and intralaminar cracks networks. As shown in FIG. 2, the production or manufacturing plants 200 of an aircraft manufacturer over the world start the NDT or non-destructive inspection by scanning the composite material parts 210 within a scanning area to generate 220 one or more cubes of raw inspection data or Full Matrix Capture (FMC). The FMC is the output data of the Ultrasonics (UT): processing of conventional UT Phased Array (PA) data 230 delivers its output to UT PA records 250 storing A-scan, B-scan and C-scan data; algorithms 240 configured to perform Total Focusing Methodology (TFM) and Phased Coherence Imaging (PCI) delivers its output to TFM and PCI records 260 storing A-scan, B-scan and C-scan data. Thus, all these output data from the UT is used by the AI models that constitute the analysis tools of detection and classification of the wide diversity of defect types 270 and, in turn, the classification outputs 190 from each of the AI models are filtered by specific acceptance criteria 280 including sizing, location on the parts or density criteria, so that the NDI system can provide a final result 290 of the inspected composite material part 210 indicating whether the composite material part 210 is ultimately acceptable or rejectable.

It is worth highlighting that all the inspection information is distributed in servers, stored in databases or other storage devices, and processed by computing devices which finally make decisions, wherein the servers, storage, databases and computing devices are shared resources over the Cloud 400. The NDI system requires equipment with a high capacity to analyze a huge amount of data quickly and accurately and also meets the requirement to establish a methodology of operation and continuous model learning from the systematic feeding of real non-destructive inspection data of parts and components that are manufactured daily in different plants around the world. Thus, the process requires the development and learning of models on an open platform to be able to interact with the input and output signals of the AI models from the different Manufacturing/Inspection Plants of the aircraft manufacturer and even other Suppliers. Therefore, a cloud security mechanism that integrates the correct management of control permissions, using encrypted and secure data, and fully protected against external and internal threats is also implemented by the NDI system.

The concept of developing machine learning models and their validation based on the deployment of shared resources interacting in the Cloud 400 allows:
Better use of hardware and software resources, and greater ease in training and refining models with a larger volume of real data.
Reduce development and updating times.
Save costs by sharing software platforms among Manufacturing/Inspection Plants, as well as allowing access to the applications from any Plant or Supplier in the world.
Possible simplifications in the process of qualifying the inspection process of Plants by having shared resources in the cloud.
Support the identification of patterns in the behaviour of the manufacturing/inspection Plants, the prediction of defects, and the identification of areas for improvement in each of the Plants by analyzing the systematic feeding of real non-destructive inspection data.

Returning to FIG. 1 which shows the equipment of the NDI system, once the curing and demoulding phase of the composite material parts 110, 210 in the autoclave is concluded, the parts or detailed specimens 111 are ready for the inspection phase. The necessary elements are:

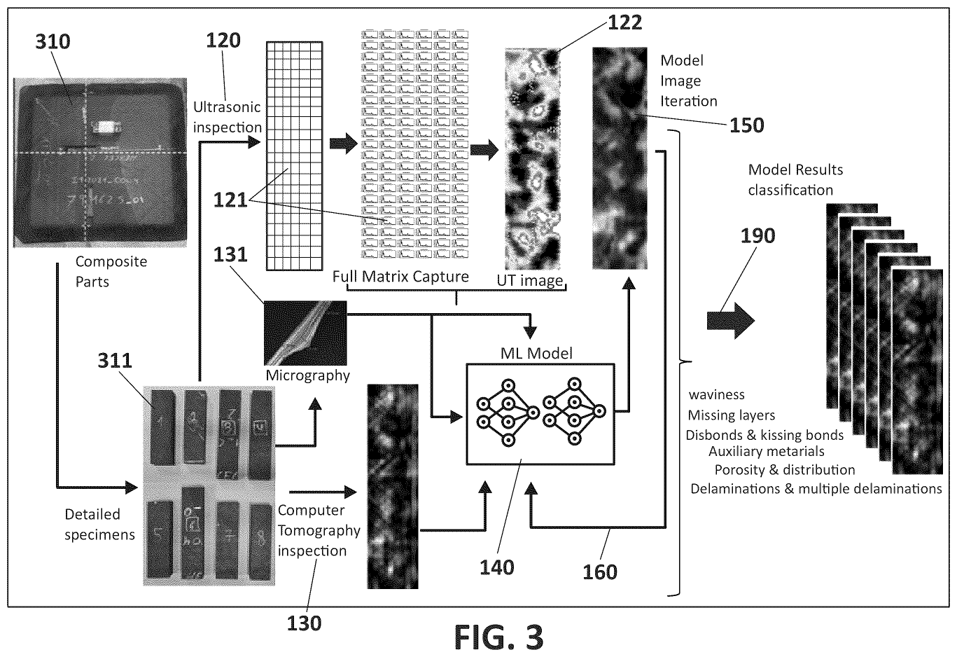

Ultrasonics (UT) inspection equipment 120 with the electronic capabilities to introduce delays in the excitation and reception of the phased array probes according to the most diverse needs for grouping of elements and sequence. The various configurations of excitation and delay ultimately introduce an acoustic field inside the material with different pressure and intensity distributions so that any discontinuity inside it produces a reflection echo, diffraction, attenuation of reference echoes, or ultimately a change in the spectrum of the signal received by the probe compared to what is expected in a homogeneous material. Examples of these electronic capabilities are the TFM (Total Focusing Methodology) or PCI (Phased Coherence Imaging) techniques. These techniques have in common the introduction of sound fields into the material that optimize sensitivity to detect and resolve internal details. These techniques generate a Full Matrix Capture 121 (FMC) or cube of raw inspection data that essentially contains information from inside the part and only the physical conditions in terms of frequency mark the limits of sensitivity and definition. The UT inspection data record associated with a given composite part can be previously treated through another file associated with the same given composite part that focuses on determining the roughness and its effect on the UT files of the given part. This roughness correction file can be obtained, for example, through an optical or mechanical profilometer or through a prior UT inspection but placing an acquisition gate at the entrance to the part. Through this process, the influence of surface roughness on the ultrasound inspection results is eliminated.
Machine learning (ML) algorithms, run by data processing of cloud-shared resources, for detection and classification of defects: The analysis and processing of the raw inspection data from the FMC 121 and from the UT image 122, obtained in the scanning of the detailed specimen 111 performed by the ultrasonics inspection equipment 120, are performed through artificial intelligence (AI) models 140 that have been created, trained, matured, and validated through a process detailed below:
a. First, it is necessary to start with real or representative composite material parts/samples that include completely healthy samples as well as parts with each of the possible defect types 270 to detect: delaminations, multiple delaminations, detection of porosity and its distribution (not only in parts with parallel faces but also in ramp configurations), unglued areas, false bonds, detection of wrinkles within the material, detection of foreign objects from the manufacturing process, and detection of defects in the number of layers as a result of inaccuracies in the composite material taping process during the production stage.
b. Second, as previously explained, a series of inspection data cubes are generated that have been obtained through various modifications in the inspection variables. Each of these modifications aims to optimize the inspection results to maximize some of the possible discontinuities to detect. The following list is an example of the possible inspection variables that generate different data cubes susceptible to being analyzed later by artificial intelligence models 140:
i. Inspection frequency (2, 3.5, 5, and 10 MHZ)
ii. Probe configuration and dimensions (Pitch and active and passive
dimension)
iii. Aperture (6, 8, 2, 16, 24, and 32)
iv. Step (1,2, and 3)
v. TCG (Time Correction Gain)—exercised by hardware or software
vi. Scanning configuration (horizontal or vertical)
vii. Index (from even <1 mm)
viii. Use of external focusing lenses
c. Third, it is necessary to perform the inspection by computed tomography (CT) at maximum resolution (a few microns) of all the selected parts. The CT process implemented by the computed tomography module 130 requires a minimum time that can be even on the order of hours, but it provides a 3D volume of the part with all the information about indications and defectology present in the parts. Apart from the 3D information of high-resolution volumes obtained by CT, extraction of sections and analysis by micrography 131 or even SEM (scanning electronic microscopy) are or can be carried out in particular cases to confirm the validity of the information obtained by the scanning process and image composition by CT. The CT and UT inspections are carried out coherently to be able to later compare and correlate results pixel by pixel in each of the obtained images and taking into account the different resolutions that may be applied between the UT and CT files in the same locations. The correlation of the successive UT files of the different composite parts and even the correlation of the UT files with CT are carried out accurately through specific references on the part. In those cases where it is possible, these references are intrinsic details of the part considering that they must be appreciable in all the parts that must be compared by any of the methods and inspection techniques used (UT: PA, TFM, or PVI) and CT. In other cases where this is not possible, markers are inserted in the manufacturing process. Preferably, there are at least three markers to be able to position and orient the parts accurately before making the comparison regardless of the orientation of the record.
d. Fourth, the creation of the AI models 140 that receive as input data the raw UT data (the corresponding data cubes from each of the scans performed) and through their machine learning algorithms extract and classify each of the defects. A model is required for each category of defects. In each model belonging to the set of artificial intelligent models 140 integrated by the system, the following architecture is distinguished:
The model input layer with a number of neurons according to the dimensions of the composite material part 110, 210 to be inspected and resolution of the inspection. This layer receives the UT inspection results, pixel by pixel extracted from the UT image 122, as an amplitude file versus time or distance for each of the possible positions taken by the inspected composite material part 110, 210.
The intermediate layers of the model are defined based on each composite part and material and the number of defects required to categorize a type of defect in the composite material part 110, 210 to be inspected.
The specific parameters of the network (number of internal layers, weights, biases, or activation functions of each neuron) are defined in the development and learning process, described below and shown in FIG. 3.
The output layer has as many neurons as categories of defects (delaminations, multiple delaminations, detection of porosity and its distribution—not only in parts with parallel faces but also in ramp configurations, debonding in stiffened skin-stringer configurations, even “kissing bonds” detection of wrinkles within the material, detection of foreign objects, lack of layers or interlaminar cracks networks.

In a preliminary stage, the AI models 140 are created and trained using selected composite parts containing selected defects, as shown in FIG. 3. The real information of the composite part used as dataset in the learning and validation phase is obtained from three pathways:
a) Computed tomography for an initial phase of model creation, and a more advanced subsequent phase in the training process but that requires a deeper analysis due to the present defectology or specific difficulties in identification and classification.
b) Ultrasound data processed manually by experts in ultrasonic data analysis.
c) Analysis of images of the interior of the material at a micro or even nano level. This pathway is applied to very specific cases that may require a deeper detail of the inside of the material or in case of doubts with the previous methods.

FIG. 3 provides a flowchart detailing the specific process used by the system for the creation and improvement of reliable AI models. Thus, selected composite material parts 310 are split into detailed specimens 311 and each of them is a composite material input for a workflow to create each of these classification AI models 140 as follows:
i. The model creation process starts from selecting representative samples/parts that contain characteristic defects that are defined as target defects to be automatically detected and classified by the model. The corresponding inspection data cubes (raw inspection data) based on the selected representative samples/parts are obtained by the UT inspection equipment 120. On the other hand, the representative samples/parts are also input into the CT module 130 to obtain the CT inspection results that comprises a recreation of a three-dimensional volume of the selected part containing complete, detailed information about its geometry, both surface and interior.
ii. The initial dataset to start creating the AI models 140 are divided into three blocks: data for learning, data for testing the model, and data for validating the model.
iii. Choice of the computational architecture of the model or algorithm: The algorithms correspond to a convolutional neural network that learns directly from the input data and allow identifying patterns in the input data in order to recognize objects, classes, and categories of defects, and extract their features. These algorithms merge the input signal (i.e., the UT data cubes) with pattern signals (called convolution kernel) that are applied in different layers to obtain a filtered output signal that through an iterative learning process is intended to contain the notable information according to the imposed detection criteria (delaminations, porosity, foreign objects, . . . ). The model outputs 150 are compared pixel by pixel with the CT information which is used as the reference information. In addition, the error and corresponding POD (probability of detection) analysis are calculated (an essential premise for the adequate qualification of the process). The ultimate goal is that rapid UT inspection and subsequent data analysis by AI models allow obtaining information similar to that obtained by CT but in a much shorter time.
iv. Optionally, the phase of creation and maturation of models can also make use of past inspection data, wherein the past inspection data are previously reconstructed into an appropriate format.
v. Finally, these models can be the result of an abstract analysis based on sequential algorithms obtained and refined from experimental data and without defined physical laws, so the practical experience and knowledge of specialists are fundamental in the validation process.

Once the created AI models 140 are implemented and qualified with a minimum established level of reliability, the inspection results continuously feed 160 these models delivering the classification outputs 190 for the different defects distinguished according to a pre-defined defectology which each AI model is configured to detect/identify. Thus, the system allows for continuous iteration, where the AI models 140 are successively refined through cycles of feedback and improvement, ensuring a constant evolution towards optimal efficacy and reliability. This iterative and feedback-based approach underscores the system's ability to adapt and continuously improve, emphasizing the importance of a perpetual improvement cycle in creating reliable AI models for the inspection of composite materials. In this way, after the UT and CT non-destructive inspection processes and extraction of the inspection data in the form of a data cube, these results are introduced into the created AI models 140 configured to indicate: i) whether there are defects or not, ii) what type of defects from the pre-defined (defectology) list of defect types 270, iii) whether they are compatible or not with the acceptance criteria 280 (including criteria of dimensions, size, location on the parts, or criteria of defect density), and iv) a final decision selected between acceptance or rejection of the inspected composite material part 110, 210, 310.

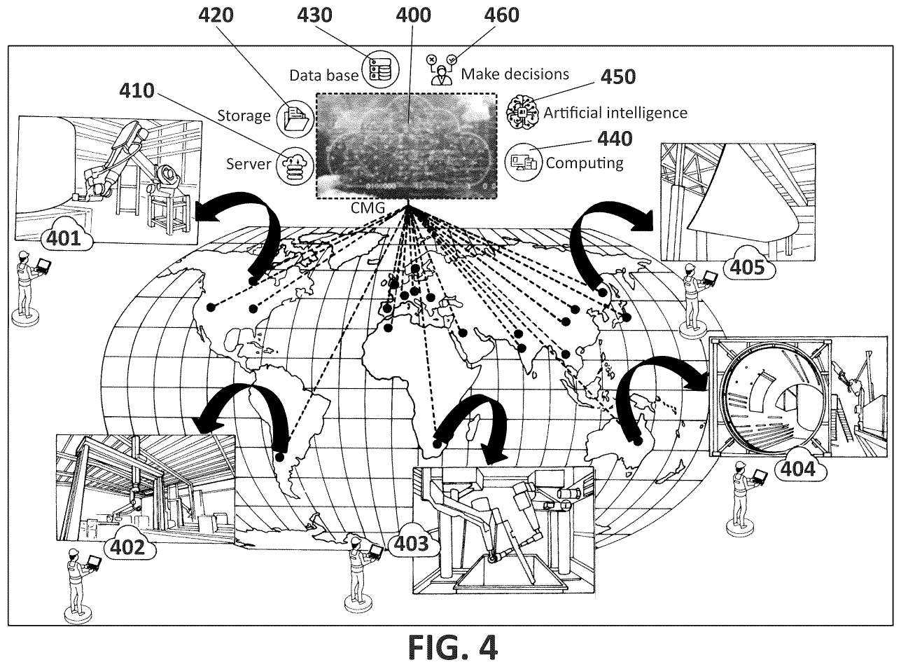

FIG. 4 summarizes all the NDT inspection equipment interconnected among each of the production plants 401, 402, 403, 404, 405 from an aircraft manufacturer and its subcontractors. The analysis of inspection results, whose data flows between components of the cloud management gateway (CMG), is carried out on software and models that are in the Cloud 400 (the Internet). The process of model validation and learning is also executed from the cloud 400. The cloud-shared resources comprise servers 410, storage 420 and databases 430, pre-built ML services and tools provided by an AI platform 440 and computer processing equipment 450 configured to distribute, store, and process inspection information containing the raw inspection data. The fact that the models are fed with all the data of aeronautical composite parts from all the plants allows for the use of 100% of the inspection results of the parts, continuous training of the models, and guarantees that data from all possible defect categories are obtained. The availability of all the inspection data from all the parts sequentially allows for additional analysis of the process evolution from the NDI inspection data with the ultimate goal of predicting possible defects and making decisions 460. It is possible to establish as an additional category in the model's output not to report defects but the possible degradation of the process over time. In other words, the consecutive comparison of the inspection files of each part at each plant allows the creation of a parameter associated with a composite part, the parameter being characteristic of the process and related to the integrity and deterioration of the process globally. This parameter fundamentally depends on the tools, the mechanics and electronics of the inspection equipment, or the lifespan of the materials, among others. The study of this parameter and its definition helps to anticipate the maintenance processes of the inspection machines, review of tooling, or calibration of autoclaves.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A non-destructive inspection system for inspecting composite material parts in a production line of aeronautics, the system comprising:
an ultrasonics inspection device configured to generate raw inspection data of the composite material parts by using phased array, total focusing methodology, and/or phased coherence imaging;
a computed tomography module configured to obtain information of volumes of the composite material parts;
a data processor of cloud-shared resources configured to receive and process the raw inspection data generated by the ultrasonics inspection device and the information obtained by the computed tomography module and to apply a set of artificial intelligent models created to identify defects within the composite material parts, the artificial intelligent models trained using an inspection dataset obtained from the ultrasonics inspection device and the computed tomography module, and each model from the set of artificial intelligent models configured to classify a type of the identified defects according to a pre-defined list of defect types and provide a classification output information.

2. The system according to claim 1, wherein the cloud-shared resources comprise, over the cloud, servers, storage, databases, artificial intelligent platform and computing processor, configured to distribute, store, and process inspection information containing the raw inspection data generated by the ultrasonics inspection device, the information obtained by the computed tomography module and the classification output information provided by the set of artificial intelligent models.

3. The system according to claim 2, wherein the cloud-shared resources implement a cloud security mechanism with encrypted and secure data management of the inspection information.

4. The system according to claim 1, wherein the artificial intelligent models are implemented by a convolutional neural network configured to identify patterns for recognizing representative composite material parts, classifying the recognized parts and identifying types of defects for each class of composite material part, by merging the raw inspection data generated by the ultrasonics inspection device with a convolution kernel of pattern signals to obtain, through an iterative learning process, an output signal comprising information according to the pre-defined list of defect types, and by comparing the output signal pixel by pixel with the information obtained by the computed tomography module.

5. The system according to claim 1, wherein each model from the set of artificial intelligent models is configured to provide a classification output which is filtered by acceptance criteria including sizing, location and density criteria of the identified defects and a final result indicating whether the composite material parts are acceptable or rejectable according to the acceptance criteria.

6. The system according to claim 1, wherein each model from the set of artificial intelligent models is created by:
incorporating an input layer of a convolutional neural network comprising a number of neurons corresponding to dimensions of a selected composite material part under inspection and a resolution of the inspection, the input layer configured to receive the raw inspection data generated by the ultrasonics inspection device for each position of the selected composite material part;
including at least an intermediate layer of the convolutional neural network defined based on the material of the selected composite material part and a number of defects to be categorized within the selected composite material part;
defining parameters for the neural network configuration, the parameters selected from a number of included internal layers, weights, biases, and activation functions of each neuron; and
incorporating an output layer of the convolutional neural network comprising a number of neurons equal to a number of defects to be categorized according to the list of defect types.

7. The system according to claim 1, wherein the raw inspection data includes full matrix capture, FMC, data.

8. The system according to claim 1, wherein the list of defect types includes delaminations, multiple delaminations, porosity and its distribution, disbonding in stiffened skin-stringer configurations, wrinkles, foreign objects from manufacturing, auxiliary material inserts, ply waviness, missing layers, intralaminar cracks networks and inaccuracies in taping composite materials in the production line.

9. The system according to claim 1, wherein the artificial intelligence models are trained using a combination of real representative parts that include both healthy samples and parts with defects pre-defined in the production line.

10. A method of non-destructive inspection of aeronautical composite material parts, the method comprising:
generating raw inspection data of a composite material part by an ultrasonics inspection device using phased array, total focusing methodology, and/or phased coherence imaging techniques;
obtaining volumetric information of the composite material part using a computed tomography module;
receiving and processing the raw inspection data generated by the ultrasonics inspection device and the volumetric information obtained by the computed tomography module through data processing means of cloud-shared resources;
applying a set of artificial intelligence models to identify defects within the composite material part, where the artificial intelligence models are trained using an inspection dataset obtained from the ultrasonics inspection device and the computed tomography module;
classifying, according to a pre-defined list of defect types, the type of identified defects in the composite material part using each model from the set of artificial intelligence models; and
providing a classification output information for the composite material part based on the classification of the type of identified defects within the composite material part.

11. The method according to claim 10, further comprising filtering the classification output by acceptance criteria including sizing, location and density criteria of the identified defects and providing a final result indicating whether the composite material part is acceptable or rejectable according to the acceptance criteria.

12. The method according to claim 10, wherein applying the set of artificial intelligence models comprises:
merging raw inspection data generated by the ultrasonics inspection device with a convolution kernel of pattern signals to identify patterns representative of composite material parts;
recognizing classes of composite material parts based on the identified patterns through an iterative learning process facilitated by the convolutional neural network;
classifying the recognized composite material parts into specific classes and identifying types of defects for each class of composite material part, where the identification and classification are based on a pre-defined list of defect types;
obtaining an output signal from the convolutional neural network that comprises information related to the classified defect types through the iterative learning process;
comparing the output signal, pixel by pixel, with information obtained by a computed tomography module to verify and refine accuracy of defect identification and classification for the composite material parts.

13. The method according to claim 10, further comprising training the artificial intelligence models using a combination of real representative parts that include both healthy samples and parts with defects pre-defined in the production line.

14. The method according to claim 10, further comprising creating each model from the set of artificial intelligent models by:
incorporating an input layer of a convolutional neural network comprising a number of neurons corresponding to the dimensions of a selected composite material part under inspection and the resolution of the inspection, the input layer configured to receive the raw inspection data generated by the ultrasonics inspection device for each position of the selected composite material part;
including at least an intermediate layer of the convolutional neural network defined based on the material of the selected composite material part and a number of defects to be categorized within the selected composite material part;
defining parameters for the neural network configuration, the parameters selected from a number of included internal layers, weights, biases, and activation functions of each neuron;
incorporating an output layer of the convolutional neural network comprising a number of neurons equal to the number of defects to be categorized according to the list of defect types.

15. The method according to claim 10, further comprising defining the list of defect types to include delaminations, multiple delaminations, porosity and its distribution, disbonding in stiffened skin-stringer configurations, wrinkles, foreign objects from manufacturing, auxiliary material inserts, ply waviness, missing layers, intralaminar cracks networks and inaccuracies in taping composite materials in the production line.
